(19) United States
(12) Patent Application Publication
(10) Pub. No.: US 2012/0237331 A1
(43) Pub. Date: Sep. 20, 2012

(54) Portable Unloading Dock

(76) Inventor: Todd Gabrielson, Grand Rapids, MN (US)

(21) Appl. No.: 13/049,105

(22) Filed: Mar. 16, 2011

(51) Int. Cl. B65G 69/30; E01D 1/00

(52) U.S. Cl. 414/800; 14/72.5

(57) ABSTRACT

A portable unloading dock including a lower frame, a first post member, a second post member, a support linkage, a curved ramp, one or more power generators, one or more first wheel apparatus, and one or more second wheel apparatus each independently mechanically coupled to the second ramp frame member. The portable unloading dock is used to transfer one or more wheeled objects from a first elevation to a second elevation. A method of using the portable unloading dock is also provided.

### BACKGROUND OF THE INVENTION

Many small businesses do not have a loading to unload rolling equipment from a truck or trailer. For example, many lawn and garden equipment retail firms typically occupy a single story building without a loading dock. The lack of a loading dock causes major safety problems if equipment, typically lawn mowers, all-terrain vehicles, snowmobiles, and the like, is delivered on in a truck trailer. To remove the equipment stock, loading ramps have to be secured from the truck bed to the ground. Typically, these loading ramps, which are made from heavy steel or aluminum, must be physically moved into position by one or more persons and can cause injury by cutting their hands or dropping onto their feet. Further, the operator unloading the equipment must be very careful to keep the wheels or tracks of the equipment on the ramp or the equipment will flip, which will cause operator injury and damage to the equipment.

What is need is a small, easily transportable unloading dock that can allow for the safe and quick unloading of equipment from one elevation to another elevation, for example, from a truck bed to the ground.

### SUMMARY OF THE INVENTION

The present invention provides a portable unloading dock that allows for the quick and safe unloading of equipment from one elevation to another without the need of a fixed elevated unloading dock. The portable unloading dock includes two wheels that allow an operator to easily move the portable unloading dock from one truck location to another truck location. Once in the desired location, the two wheels are raised to lower the bottom frame to the ground to provide a secure foundation. The operator adjusts the level of the curved ramp to the height of the truck or trailer bed and the equipment is safely unloaded. The curvature of the ramp improves the ability of equipment, for example, lawn mowers, to ascend the ramp relative to a liner or straight ramp because it allows the equipment to ascend a higher vertical slope in less horizontal space.

The present invention provides a portable unloading dock. The portable unloading dock includes: a lower frame including: a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member; one or more power generators each independently mechanically coupled to or electrically coupled to the one or more support lifting members to raise the proximal end of the curved ramp; one or more first wheel apparatus each independently mechanically coupled to the first ramp frame member; and one or more second wheel apparatus each independently mechanically coupled to the second ramp frame member; wherein the portable unloading dock is used to transfer one or more wheeled objects from a first elevation to a second elevation.

In one embodiment, the portable loading dock further includes a first ramp guard member mechanically coupled to the first ramp frame member or to the first surface of the curved ramp. In one embodiment, the first ramp guard member is a curved guard member. In one embodiment, the portable loading dock further includes a second ramp guard member mechanically coupled to the second ramp frame member or to the first surface of the curved ramp. In one embodiment, the second ramp guard member is a curved guard member.

In one embodiment, each proximal end of the one or more optional third cross-frame members is independently mechanically coupled to and between the proximal end and distal end of the first lower frame member. In one embodiment, each distal end of the one or more optional third cross-frame members is independently mechanically coupled to and between the proximal end and distal end of the second lower frame member. In one embodiment, the proximal end of the first post member is mechanically coupled perpendicular to the proximal end of the first lower frame member, the proximal end of the first cross-frame member, or a combination thereof.

In one embodiment, the proximal end of the second post member is mechanically coupled perpendicular to the proximal end of the second lower frame member, the distal end of the first cross-frame member, or a combination thereof. In one embodiment, each of the proximal ends of the one or more support linkage members is independently mechanically coupled to and between the proximal end and the distal end of the first cross-frame member.

In one embodiment, each of the distal ends of the one or more support linkage members is independently mechanically coupled to and between the proximal ends and the distal ends of the one or more optional third cross-frame members or the second cross-frame member. In one embodiment, each of the proximal ends of the one or more support lifting members is independently mechanically coupled to and between the proximal ends and the distal ends of the one or more support linkage members, the one or more optional third cross-frame members, or the second cross-frame member.

In one embodiment, each proximal end of the one or more optional third ramp cross-frame members is independently mechanically coupled to and between the proximal end and distal end of the first ramp frame member. In one embodiment, each distal end of the one or more optional third ramp cross-frame members is independently mechanically coupled to and between the proximal end and distal end of the second ramp frame member.

In one embodiment, the first surface of the curved ramp includes one or more grates, one or more solid plates, or a combination thereof. In one embodiment, the first surface of the curved ramp includes one or more grates. In one embodiment, the first surface of the curved ramp includes one or more solid plates. In one embodiment, the one or more support lifting members each independently include one or more hydraulic cylinders, one or more compressed gas cylinders, or a combination thereof. In one embodiment, the one or more support lifting members each independently include one or more hydraulic cylinders. In one embodiment, the one or more support lifting members each independently include one or more gas cylinders.

In one embodiment, the one or more power generators each independently include one or more hydraulic fluid compressors, one or more gas compressors, one or more compressed gas cylinders, one or more electrical power sources, or a combination thereof. In one embodiment, the one or more power generators each independently include one or more hydraulic fluid compressors. In one embodiment, the one or more power generators each independently include one or more gas compressors. In one embodiment, the one or more power generators each independently include one or more compressed gas cylinders. In one embodiment, the one or more power generators each independently include one or more electrical power sources.

In one embodiment, the one or more first wheel apparatus and the one or more second wheel apparatus are lowered to raise the portable unloading dock off a first elevation enable a user to transport the portable unloading dock. In one embodiment, the one or more first wheel apparatus and the one or more second wheel apparatus are raised to place the portable unloading dock on a floor to enable a user to transfer one or more vehicles from a first elevation to a second elevation.

In one embodiment, the one or more first wheel apparatus and the one or more second wheel apparatus are raised to place the portable unloading dock on a floor to enable a user to transfer one or more vehicles from a truck bed or trailer bed to the floor or from the floor to a truck bed or a trailer bed. In one embodiment, the second surface is mechanically coupled to the two or more ramp frame members, the first cross ramp frame member, the second cross ramp frame member, the one or more optional third cross ramp frame members, or a combination thereof.

In one embodiment, the first elevation is higher than the second elevation. In one embodiment, the first elevation is lower than the second elevation. In one embodiment, the first elevation includes a truck bed, a trailer bed, or a first loading dock. In one embodiment, the second elevation includes a floor.

In one embodiment, the one or more power generators are each independently mechanically coupled to the lower frame, the curved ramp, or a combination thereof. In one embodiment, the one or more power generators are each independently mechanically coupled to the lower frame.

In one embodiment, the one or more power generators are each independently mechanically coupled to the curved ramp. In one embodiment, the one or more power generators are each independently mechanically coupled to the lower frame or to the curved ramp. In one embodiment, the distal end of the curved ramp is mechanically coupled to the second cross-frame member to pivot about the second cross-frame member when the one or more power generators supply a force to the one or more support lifting members to raise the proximal end of the curved ramp.

In one embodiment, the portable unloading dock further includes one or more first limit sensors to prevent the curved ramp from traveling in an upward direction beyond a predetermined height. In one embodiment, the portable unloading dock further includes one or more second limit sensors to prevent the curved ramp from traveling in a downward direction beyond a predetermined height.

In one embodiment, the portable unloading dock further includes a system controller operatively coupled to the portable unloading dock. In one embodiment, the system controller is operatively coupled to the one or more power generators, the one or more first limit sensors, the one or more second limit sensors, or a combination thereof.

In one embodiment, the system controller includes a programmable microprocessor, a microcontroller, an application specific integrated circuit, a programmable logic array, or a combination thereof. In one embodiment, the portable unloading dock further includes one or more environmental sensors. In one embodiment, the one or more environmental sensors each independently detect the presence of one or more foreign objects in front of the portable unloading dock, behind the portable unloading dock, inside the portable unloading dock, under the portable unloading dock, on top of the portable unloading dock, or a combination thereof.

In one embodiment, the one or more wheeled objects each independently include one or more vehicles, one or more wheeled platforms, one or more wheeled appliances, one or more pieces of wheeled furniture, or a combination thereof. In one embodiment, the one or more vehicles each independently include one or more tractors, one or more utility vehicles, one or more trailers, one or more lawn mowers, one or more all-terrain vehicles, one or more snowmobiles, one or more automobiles, one or more trucks, one or more snow blowers, one or more snow plows, one or more lift trucks, one or more mechanical cranes, one or more man-lifters, one or more vans, one or more recreational vehicles, one or more golf carts, one or more pieces of wheeled farm equipment, or a combination thereof.

In one embodiment, the one or more wheeled platforms each independently include one or more moving dollies, one or more platform carts, one or more hand trucks, one or more shopping carts, or a combination thereof. In one embodiment, the one or more pieces of wheeled furniture include one or more wheeled cabinets, one or more wheeled benches, one or more wheeled chairs, one or more wheeled bookcases, one of more wheeled desks, or a combination thereof.

In one embodiment, the portable unloading dock further includes one or more first swinging ramps each independently mechanically coupled to the proximal end of the curved ramp. In one embodiment, the portable unloading dock further includes one or more second swinging ramps each independently mechanically coupled to the distal end of the curved ramp. In one embodiment, the portable unloading dock further includes one or more power sources each independently operatively coupled to the one or more power generators. In one embodiment, the one or more power sources each independently include one or more batteries, one or more alternating current sources, one or more direct current sources, one or more internal combustion engines, or a combination thereof.

The present invention provides a portable unloading dock. The portable unloading dock includes: a lower frame including: a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member, wherein the one or more support lifting members include one or more hydraulic cylinders; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member, wherein the first surface of the curved ramp includes one or more grates; one or more power generators each independently mechanically coupled to or electrically coupled to the one or more support lifting members to raise the proximal end of the curved ramp, wherein the one or more power generators include one or more hydraulic fluid compressors; one or more first wheel apparatus each independently mechanically coupled to the first ramp frame member; one or more second wheel apparatus each independently mechanically coupled to the second ramp frame member; a first ramp guard member mechanically coupled to the first ramp frame member or to the first surface of the curved ramp; and a second ramp guard member mechanically coupled to the second ramp frame member or to the first surface of the curved ramp, wherein the portable unloading dock is used to transfer one or more wheeled objects from a first elevation to a second elevation.

The present invention provides a portable unloading dock. The portable unloading dock includes: a lower frame including: a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member, wherein the one or more support lifting members include one or more hydraulic cylinders; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member, wherein the first surface of the curved ramp includes one or more grates; one or more power generators each independently mechanically coupled to or electrically coupled to the one or more support lifting members to raise the proximal end of the curved ramp, wherein the one or more power generators include one or more hydraulic fluid compressors; one or more first wheel apparatus each independently mechanically coupled to the first ramp frame member; one or more second wheel apparatus each independently mechanically coupled to the second ramp frame member; a first ramp guard member mechanically coupled to the first ramp frame member or to the first surface of the curved ramp; and a second ramp guard member mechanically coupled to the second ramp frame member or to the first surface of the curved ramp, one or more power sources operatively coupled to the one or more power generators; one or more first swinging ramps each independently mechanically coupled to the proximal end of the curved ramp; one or more second swinging ramps each independently mechanically coupled to the distal end of the curved ramp; one or more environmental sensors; one or more first limit sensors to prevent the curved ramp from traveling in an upward direction beyond a predetermined height; one or more second limit sensors to prevent the curved ramp from traveling in a downward direction beyond a predetermined height; and a system controller operatively coupled to the portable unloading dock; wherein the portable unloading dock is used to transfer one or more wheeled objects from a first elevation to a second elevation.

The present invention provides a method of transferring one or more wheeled objects from a first elevation to a second elevation. The method includes: providing a portable unloading dock including: a lower frame including: a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member; one or more power generators each independently mechanically coupled to or electrically coupled to the one or more support lifting members to raise the proximal end of the curved ramp; one or more first wheel apparatus each independently mechanically coupled to the first ramp frame member; and one or more second wheel apparatus each independently mechanically coupled to the second ramp frame member; moving the portable unloading dock to a first elevation; securing the portable unloading dock to a first elevation by raising the first wheel and the second wheel off the first elevation; adjusting the curved ramp to the first elevation; transferring the one or more wheeled objects from the first elevation onto the portable unloading dock; and transferring the one or more wheeled objects from the portable unloading dock to the second elevation.

The present invention provides a method of transferring one or more wheeled objects from a first elevation to a second elevation. The method includes: providing a portable unloading dock including: a lower frame including; a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member, wherein the one or more support lifting members include one or more hydraulic cylinders; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member, wherein the first surface of the curved ramp includes one or more grates; one or more power generators each independently mechanically coupled to or electrically coupled to the one or more support lifting members to raise the proximal end of the curved ramp, wherein the one or more power generators include one or more hydraulic fluid compressors; one or more first wheel apparatus each independently mechanically coupled to the first ramp frame member; one or more second wheel apparatus each independently mechanically coupled to the second ramp frame member; a first ramp guard member mechanically coupled to the first ramp frame member or to the first surface of the curved ramp; and a second ramp guard member mechanically coupled to the second ramp frame member or to the first surface of the curved ramp, wherein the portable unloading dock is used to transfer one or more wheeled objects from a first elevation to a second elevation; moving the portable unloading dock to a first elevation; securing the portable unloading dock to a first elevation by raising the first wheel and the second wheel off the first elevation; adjusting the curved ramp to the first elevation; transferring the one or more wheeled objects from the first elevation onto the portable unloading dock; and transferring the one or more wheeled objects from the portable unloading dock to the second elevation.

The present invention provides a method of transferring one or more wheeled objects from a first elevation to a second elevation. The method includes: providing a portable unloading dock including: a lower frame including: a first lower frame member having a proximal end and a distal end; a second lower frame member having a proximal end and a distal end, wherein the first lower frame member and the second lower frame member are substantially parallel to each other; a first cross-frame member having a proximal end and a distal end, wherein the proximal end of the first cross member is mechanically coupled to the proximal end of the first lower frame member and the distal end of the first cross member is mechanically coupled to the proximal end of the second lower frame member; a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member; one or more optional third cross-frame members each having a proximal end and a distal end, wherein each proximal end of the one or more optional third cross-frame members is independently mechanically coupled to the first lower frame member; wherein each distal end of the one or more optional third cross-frame members is independently mechanically coupled to the second lower frame member; a first post member having a proximal end and a distal end, wherein the proximal end is mechanically coupled to the proximal end of the first lower frame member, the proximal end of the first cross-frame member, or a combination thereof; a second post member having a proximal end and a distal end, wherein the proximal end is mechanically coupled to the proximal end of the second lower frame member, the distal end of the first cross-frame member, or a combination thereof; a support linkage including: one or more support linkage members each having a proximal end and a distal end, wherein each of the proximal ends of the one or more support linkage members is independently mechanically coupled to the first cross-frame member, and wherein each of the distal ends of the one or more support linkage members is independently mechanically coupled to the proximal ends and the distal ends of the one or more optional third cross-frame members or the second cross-frame member; one or more support lifting members each having a proximal end and a distal end, wherein each of the proximal ends of the one or more support lifting members is independently mechanically coupled to the proximal ends and the distal ends of the one or more support linkage members, the one or more optional third cross-frame members, or the second cross-frame member, wherein the one or more support lifting members include one or more hydraulic cylinders; a curved ramp having a proximal end, a distal end, a first surface, and a second surface, wherein the curved ramp includes: a first ramp frame member having a proximal end and a distal end; a second ramp frame member having a proximal end and a distal end, wherein the first ramp frame member and the second ramp frame member are substantially parallel to each other; a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member; a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member; one or more optional third ramp cross-frame members each having a proximal end and a distal end, wherein each proximal end of the one or more optional third ramp cross-frame members is independently mechanically coupled to the first ramp frame member, wherein each distal end of the one or more optional third ramp cross-frame members is independently mechanically coupled to the second ramp frame member, wherein the curved ramp is mechanically coupled to each of the distal ends of the one or more support lifting members, wherein the distal end of the curved ramp is mechanically coupled to the second cross-frame member, wherein the first surface of the curved ramp includes one or more grates; one or more power generators each independently mechanically coupled to or electrically coupled to the one or more support lifting members to raise the proximal end of the curved ramp, wherein the one or more power generators include one or more hydraulic fluid compressors; one or more first wheel apparatus each independently mechanically coupled to the first ramp frame member; one or more second wheel apparatus each independently mechanically coupled to the second ramp frame member; a first ramp guard member mechanically coupled to the first ramp frame member or to the first surface of the curved ramp; and a second ramp guard member mechanically coupled to the second ramp frame member or to the first surface of the curved ramp; one or more power sources operatively coupled to the one or more power generators; one or more first swinging ramps each independently mechanically coupled to the proximal end of the curved ramp; one or more second swinging ramps each independently mechanically coupled to the distal end of the curved ramp; one or more environmental sensors; one or more first limit sensors to prevent the curved ramp from traveling in an upward direction beyond a predetermined height; one or more second limit sensors to prevent the curved ramp from traveling in a downward direction beyond a predetermined height; and a system controller operatively coupled to the portable unloading dock; wherein the portable unloading dock is used to transfer one or more wheeled objects from a first elevation to a second elevation; moving the portable unloading dock to a first elevation; securing the portable unloading dock to a first elevation by raising the first wheel and the second wheel off the first elevation; adjusting the curved ramp to the first elevation; transferring the one or more wheeled objects from the first elevation onto the portable unloading dock; and transferring the one or more wheeled objects from the portable unloading dock to the second elevation.

### BRIEF DESCRIPTION OF THE DRAWINGS

Embodiments of the invention may be best understood by referring to the following description and accompanying drawings, which illustrate such embodiments. In the drawings:

FIG. 1 is a side-view drawing illustrating an exemplary portable unloading dock in transit mode.

FIG. 2 is a side-view drawing illustrating an exemplary portable unloading dock in fixed mode with the curved ramp in the extended position.

FIG. 3 is a side-view drawing illustrating an exemplary portable unloading dock in fixed mode with the curved ramp in the lowered position.

FIG. 4 is a top-view drawing illustrating an exemplary portable unloading dock.

FIG. 5 is a bottom-view drawing illustrating an exemplary portable unloading dock.

FIG. 6 is a left-side-view drawing illustrating an exemplary portable unloading dock in fixed mode with the curved ramp in the extended position.

FIG. 7 is a left-side-view drawing illustrating an exemplary portable unloading dock in transit mode with the curved ramp in the lowered position.

FIG. 8 is a block diagram illustrating a method of transferring one or more wheeled objects from a first elevation to a second elevation.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a portable unloading dock that allows for the quick and safe unloading of equipment from one elevation to another without the need of a fixed elevated unloading dock. The portable unloading dock includes two wheels that allow an operator to easily move the portable unloading dock from one truck location to another truck location. Once in the desired location, the two wheels are raised to lower the bottom frame to the ground to provide a secure foundation. The operator adjusts the level of the curved ramp to the height of the truck or trailer bed and the equipment is safely unloaded. The curvature of the ramp improves the ability of equipment, for example, lawn mowers, to ascend the ramp relative to a liner or straight ramp because it allows the equipment to ascend a higher vertical slope in less horizontal space.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

The following explanations of certain terms are meant to be illustrative rather than exhaustive. These terms have their ordinary meanings given by usage in the art and in addition include the following explanations.

As used herein, the term “about” refers to a variation of 10 percent of the value specified; for example about 50 percent carries a variation from 45 to 55 percent.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the phrase “curved ramp” refers to a ramp that is not linear or straight. The curvature improves the ability of equipment, for example, lawn mowers, to ascend and descend the ramp relative to a liner or straight ramp.

As used herein, the phrase “electrically coupled” refers to bringing two or more items together or into relationship with each other in any number of ways including: a direct, indirect, or inductive communication connection, a direct/indirect or inductive power connection, or a combination thereof.

As used herein, the terms “include,” “for example,” “such as,” and the like are used illustratively and are not intended to limit the present invention.

As used herein, the phrase “mechanically coupled” refers to bringing two or more items together or into relationship with each other in any number of ways including a direct or indirect physical connection that may be releasable (snaps, rivets, screws, bolts, welds, etc.), movable (rotating, pivoting, oscillating, etc.), or a combination thereof.

As used herein, the phrase “operatively coupled” refers to bringing two or more items together or into relationship with each other such that they may operate together or allow transfer of information between the two or more items.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the phrase “portable unloading dock” refers to an unloading dock, which is able to be carried or moved by a person.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

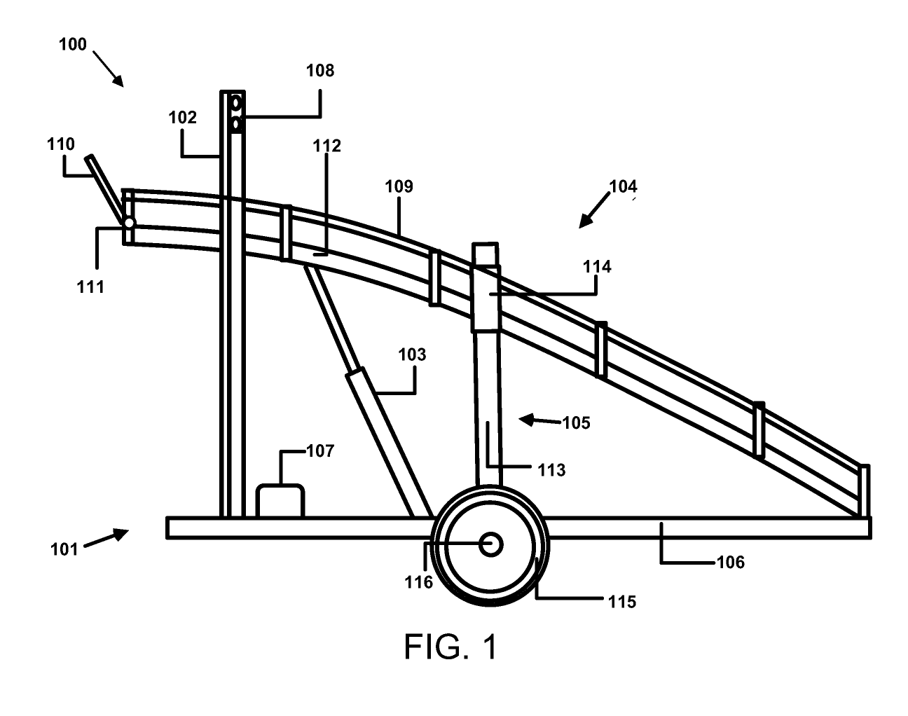

FIG. 1 is a side-view drawing illustrating an exemplary portable unloading dock 100 in transit mode. The portable unloading dock 100 includes a lower frame 101, a first post member 102, a second post member (not shown), a support linkage (not shown), a first support lifting member 103, a second support lifting member (not shown), a curved ramp 104, a first wheel apparatus 105, and a second wheel apparatus (not shown). The lower frame 101 includes first lower frame member 106, a second lower frame member (not shown), a first cross-frame member (not shown), a second cross-frame member (not shown), and a third cross-frame member (not shown).

In one embodiment, a power generator 107 is mechanically coupled to the support linkage (not shown). In another embodiment, the power generator 107 is mechanically coupled to the first cross-frame member (not shown). In yet another embodiment, the power generator 107 is mechanically coupled to the third cross-frame member (not shown).

The first post member 102 includes a control switch 108, which is used to control the raising and the lowering of the curved ramp 104.

In one embodiment, the first post member 102 is mechanically coupled to first lower frame member 106. In another embodiment, the first post member 102 is mechanically coupled to first cross-frame member (not shown). In yet another embodiment, the first post member 102 is mechanically coupled to both the first lower frame member 106 and the first cross-frame member (not shown).

The support linkage (not shown) includes a first support linkage member (not shown), a second support linkage member (not shown), a first support lifting member 103, and a second support lifting member (not shown).

The curved ramp 104 is mechanically coupled to the lower frame 101, and pivots about the second cross-frame member (not shown) when the curved ramp 104 is raised and lowered. The curved ramp 104 also includes a first ramp guard member 109, a second ramp guard member (not shown), and a second ramp 110 that is mechanically coupled to the hinge 111. The second ramp 110 may be lowered on to the truck bed to allow for easy transfer of wheeled vehicles from the truck bed to the portable unloading dock 100. The curve ramp 104 also includes a first ramp frame member 112, a second ramp frame member (not shown), a first cross ramp frame member (not shown), a second cross ramp frame member (not shown), and a third cross ramp frame member (not shown).

The first wheel apparatus 105 includes a first wheel shaft 113, a first wheel shaft coupler 114, a first wheel 115, and a first wheel axle 116. The first wheel shaft coupler 114 is mechanically coupled to the curved ramp 104 and allows the first wheel apparatus 105 to be raised and lowered. In FIG. 1, the first wheel apparatus 105 is in the lowered position, which enables the portable unloading dock 100 to be moved from one location to another location.

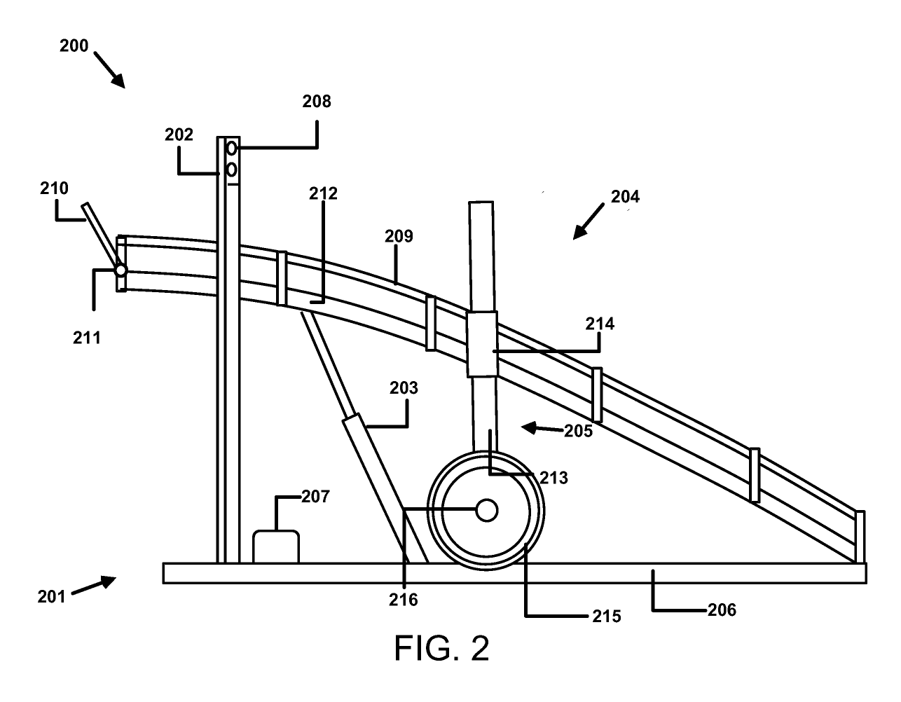

FIG. 2 is a side-view drawing illustrating an exemplary portable unloading dock 200 in fixed mode with the curved ramp in the extended position. The portable unloading dock 200 includes a lower frame 201, a first post member 202, a second post member (not shown), a support linkage (not shown), a first support lifting member 203, a second support lifting member (not shown), a curved ramp 204, a first wheel apparatus 205, and a second wheel apparatus (not shown). The lower frame 201 includes first lower frame member 206, a second lower frame member (not shown), a first cross-frame member (not shown), a second cross-frame member (not shown), and a third cross-frame member (not shown).

In one embodiment, a power generator 207 is mechanically coupled to the support linkage (not shown). In another embodiment, the power generator 207 is mechanically coupled to the first cross-frame member (not shown). In yet another embodiment, the power generator 207 is mechanically coupled to the third cross-frame member (not shown).

The first post member 202 includes a control switch 208, which is used to control the raising and the lowering of the curved ramp 204.

In one embodiment, the first post member 202 is mechanically coupled to first lower frame member 206. In another embodiment, the first post member 202 is mechanically coupled to first cross-frame member (not shown). In yet another embodiment, the first post member 202 is mechanically coupled to both the first lower frame member 206 and the first cross-frame member (not shown).

The support linkage (not shown) includes a first support linkage member (not shown), a second support linkage member (not shown), a first support lifting member 203, and a second support lifting member (not shown).

The curved ramp 204 is mechanically coupled to the lower frame 201, and pivots about the second cross-frame member (not shown) when the curved ramp 204 is raised and lowered. The curved ramp 204 also includes a first ramp guard member 209, a second ramp guard member (not shown), and a second ramp 210 that is mechanically coupled to the hinge 211. The second ramp 210 may be lowered on to the truck bed to allow for easy transfer of wheeled vehicles from the truck bed to the portable unloading dock 200. The curve ramp 204 also includes a first ramp frame member 212, a second ramp frame member (not shown), a first cross ramp frame member (not shown), a second cross ramp frame member (not shown), and a third cross ramp frame member (not shown).

The first wheel apparatus 205 includes a first wheel shaft 213, a first wheel shaft coupler 214, a first wheel 215, and a first wheel axle 216. The first wheel shaft coupler 214 is mechanically coupled to the curved ramp 204 and allows the first wheel apparatus 205 to be raised and lowered. In FIG. 2, the first wheel apparatus 205 is in the raised position, which places the portable unloading dock 200 on the floor and the curved ramp 204 is in the extended position.

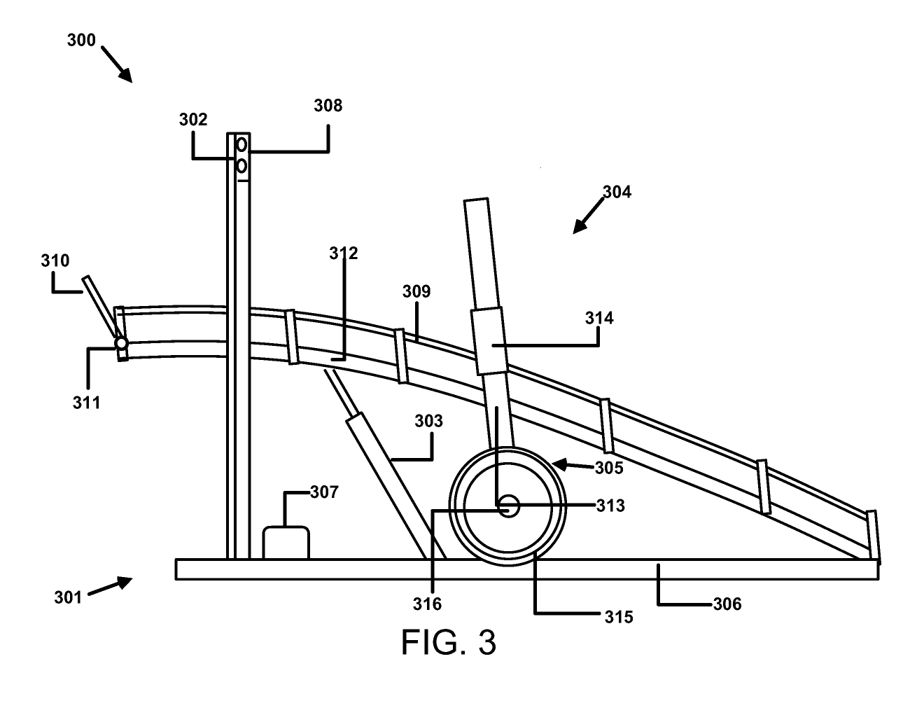

FIG. 3 is a side-view drawing illustrating an exemplary portable unloading dock 300 in fixed mode with the curved ramp in the lowered position. The portable unloading dock 300 includes a lower frame 301, a first post member 302, a second post member (not shown), a support linkage (not shown), a first support lifting member 303, a second support lifting member (not shown), a curved ramp 304, a first wheel apparatus 305, and a second wheel apparatus (not shown). The lower frame 301 includes first lower frame member 306, a second lower frame member (not shown), a first cross-frame member (not shown), a second cross-frame member (not shown), and a third cross-frame member (not shown).

In one embodiment, a power generator 307 is mechanically coupled to the support linkage (not shown). In another embodiment, the power generator 307 is mechanically coupled to the first cross-frame member (not shown). In yet another embodiment, the power generator 307 is mechanically coupled to the third cross-frame member (not shown).

The first post member 302 includes a control switch 308, which is used to control the raising and the lowering of the curved ramp 304.

In one embodiment, the first post member 302 is mechanically coupled to first lower frame member 306. In another embodiment, the first post member 302 is mechanically coupled to first cross-frame member (not shown). In yet another embodiment, the first post member 302 is mechanically coupled to both the first lower frame member 306 and the first cross-frame member (not shown).

The support linkage (not shown) includes a first support linkage member (not shown), a second support linkage member (not shown), a first support lifting member 303, and a second support lifting member (not shown).

The curved ramp 304 is mechanically coupled to the lower frame 301, and pivots about the second cross-frame member (not shown) when the curved ramp 304 is raised and lowered. The curved ramp 304 also includes a first ramp guard member 309, a second ramp guard member (not shown), and a second ramp 310 that is mechanically coupled to the hinge 311. The second ramp 310 may be lowered on to the truck bed to allow for easy transfer of wheeled vehicles from the truck bed to the portable unloading dock 300. The curved ramp 304 also includes a first ramp frame member 312, a second ramp frame member (not shown), a first cross ramp frame member (not shown), a second cross ramp frame member (not shown), and a third cross ramp frame member (not shown).

The first wheel apparatus 305 includes a first wheel shaft 313, a first wheel shaft coupler 314, a first wheel 315, and a first wheel axle 316. The first wheel shaft coupler 314 is mechanically coupled to the curved ramp 304 and allows the first wheel apparatus 305 to be raised and lowered. In FIG. 3, the first wheel apparatus 305 is in the raised position, which places the portable unloading dock 300 on the floor and the curved ramp 304 is in the lowered position.

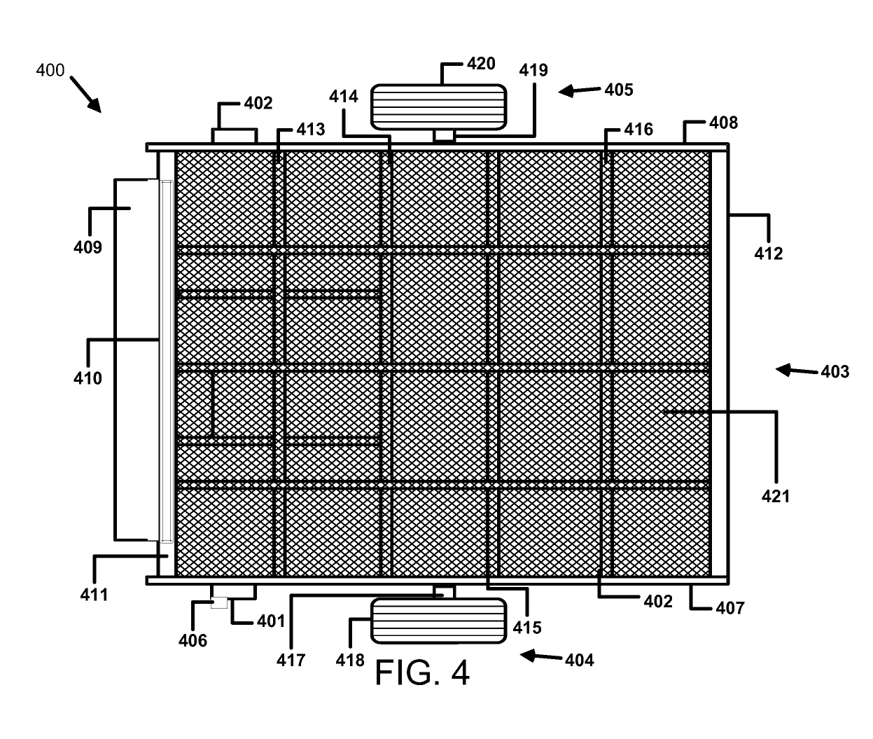

FIG. 4 is a top-view drawing illustrating an exemplary portable unloading dock 400. The portable unloading dock 400 includes a lower frame (not shown), a first post member 401, a second post member 402, a curved ramp 403, a first wheel apparatus 404, and a second wheel apparatus 405. The first post member 401 includes a control switch 406, which is used to control the raising and the lowering of the curved ramp 403.

The curved ramp 403 is mechanically coupled to the lower frame (not shown), and pivots about the second cross-frame member (not shown) when the curved ramp 403 is raised and lowered. The curved ramp 403 also includes a first ramp guard member 407, a second ramp guard member 408, and a second ramp 409 that is mechanically coupled to the hinge 410. The second ramp 409 may be lowered on to the truck bed to allow for easy transfer of wheeled vehicles from the truck bed to the portable unloading dock 400. The curved ramp 403 also includes a first ramp frame member (not shown), a second ramp frame member (not shown), a first cross ramp frame member 411, a second cross ramp frame member 412, a third cross ramp frame member 413, a fourth cross ramp frame member 414, a fifth cross ramp frame member 415, and a sixth cross ramp frame member 416.

The first wheel apparatus 404 includes a first wheel shaft 417, and a first wheel 418. The second wheel apparatus 405 includes a second wheel shaft 419, and a second wheel 420. The curved ramp 403 also includes a grated surface 421.

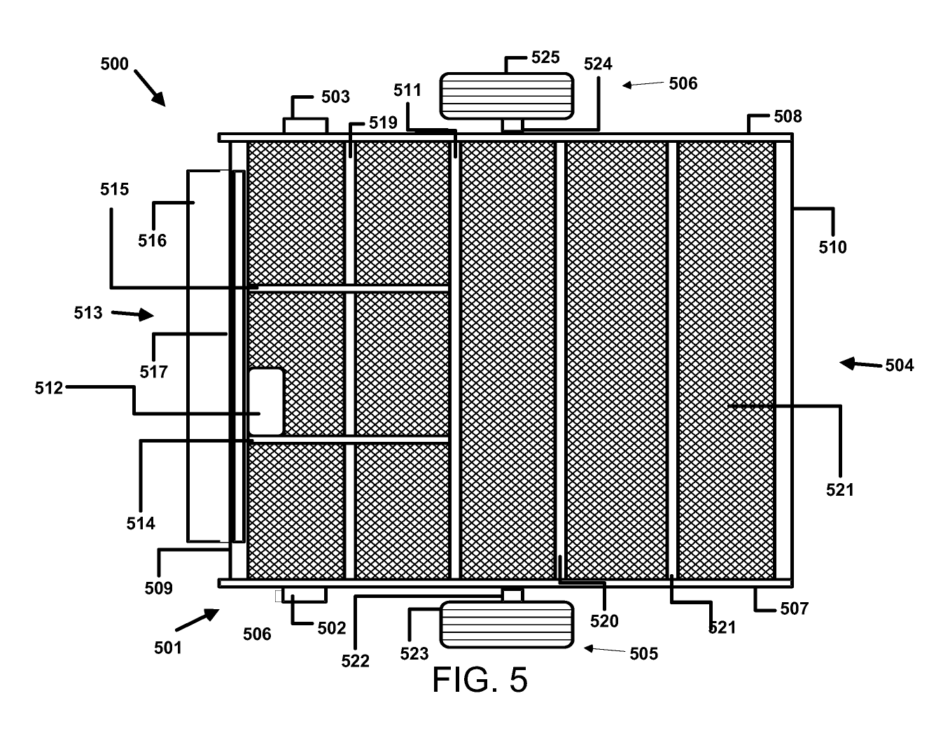

FIG. 5 is a bottom-view drawing illustrating an exemplary portable unloading dock 500. The portable unloading dock 500 includes a lower frame 501, a first post member 502, a second post member 503, a curved ramp 504, a first wheel apparatus 505, and a second wheel apparatus 506. The lower frame 501 includes first lower frame member 507, a second lower frame member 508, a first cross-frame member 509, a second cross-frame member 510, and a third cross-frame member 511.

In one embodiment, a power generator 512 is mechanically coupled to the support linkage 513. In another embodiment, the power generator 512 is mechanically coupled to the first cross-frame member 509. In yet another embodiment, the power generator 512 is mechanically coupled to the third cross-frame member 511.

In one embodiment, the first post member 502 is mechanically coupled to first lower frame member 507.

The support linkage 513 includes a first support linkage member 514, a second support linkage member 515, a first support lifting member (not shown), and a second support lifting member (not shown).

The curved ramp 504 is mechanically coupled to the lower frame 501, and pivots about the second cross-frame member 510 when the curved ramp 504 is raised and lowered. The curved ramp 504 also includes a second ramp 516 that is mechanically coupled to the hinge 517. The second ramp 516 may be lowered on to the truck bed to allow for easy transfer of wheeled vehicles from the truck bed to the portable unloading dock 500. The curved ramp 504 also includes a first ramp frame member (not shown), a second ramp frame member (not shown), a first cross ramp frame member (not shown), a second cross ramp frame member (not shown), a third cross ramp frame member 519, a fourth cross ramp frame member (not shown), a fifth cross ramp frame member 520, and a sixth cross ramp frame member 521.

The first wheel apparatus 505 includes a first wheel shaft 522, and a first wheel 523. The second wheel apparatus 506 includes a second wheel shaft 524, and a second wheel 525.

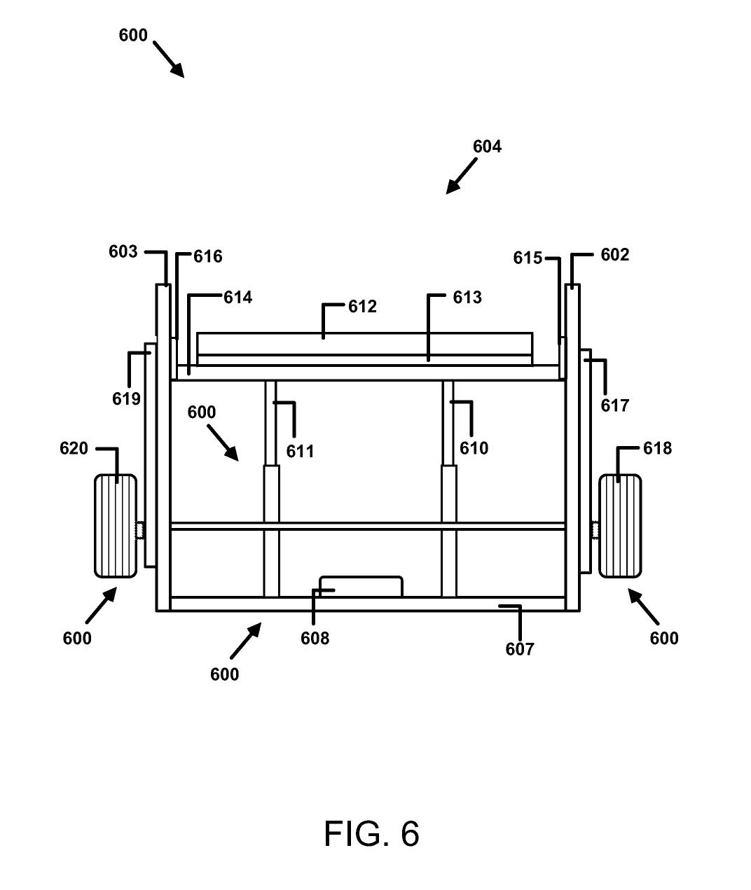

FIG. 6 is a left-side-view drawing illustrating an exemplary portable unloading dock 600 in fixed mode with the curved ramp in the extended position. The portable unloading dock 600 includes a lower frame 601 a first post member 602, a second post member 603, a curved ramp 604, a first wheel apparatus 605, and a second wheel apparatus 606.

The lower frame 601 includes first lower frame member (not shown), a second lower frame member (not shown), a first cross-frame member 607, a second cross-frame member (not shown), and a third cross-frame member (not shown).

In one embodiment, a power generator 608 is mechanically coupled to the support linkage 609. In another embodiment, the power generator 608 is mechanically coupled to the first cross-frame member 607. In yet another embodiment, the power generator 608 is mechanically coupled to the third cross-frame member (not shown).

In one embodiment, the first post member 602 is mechanically coupled to first lower frame member (not shown).

The support linkage 609 includes a first support linkage member (not shown), a second support linkage member (not shown), a first support lifting member 610, and a second support lifting member 611.

The curved ramp 604 is mechanically coupled to the lower frame 601, and pivots about the second cross-frame member (not shown) when the curved ramp 604 is raised and lowered. The curved ramp 604 also includes a second ramp 612 that is mechanically coupled to the hinge 613. The second ramp 612 may be lowered on to the truck bed to allow for easy transfer of wheeled vehicles from the truck bed to the portable unloading dock 600. The curve ramp 604 also includes a first ramp frame member 614, a second ramp frame member 615, a first cross ramp frame member 616, a second cross ramp frame member (not shown), and a third cross ramp frame member (not shown).

The first wheel apparatus 605 includes a first wheel shaft 617, a first wheel shaft coupler (not shown), a first wheel 618, and a first wheel axle (not shown). The first wheel shaft coupler (not shown) is mechanically coupled to the curved ramp 604 and allows the first wheel apparatus 605 to be raised and lowered. In FIG. 6, the first wheel apparatus 605 is in the raised position, which places the portable unloading dock 600 on the floor and the curved ramp 604 is in the extended position.

The second wheel apparatus 606 includes a second wheel shaft 619, a second wheel shaft coupler (not shown), a second wheel 620, and a second wheel axle (not shown). The second wheel shaft coupler (not shown) is mechanically coupled to the curved ramp 604 and allows the second wheel apparatus 606 to be raised and lowered. In FIG. 6, the second wheel apparatus 606 is in the raised position, which places the portable unloading dock 600 on the floor and the curved ramp 604 is in the extended position.

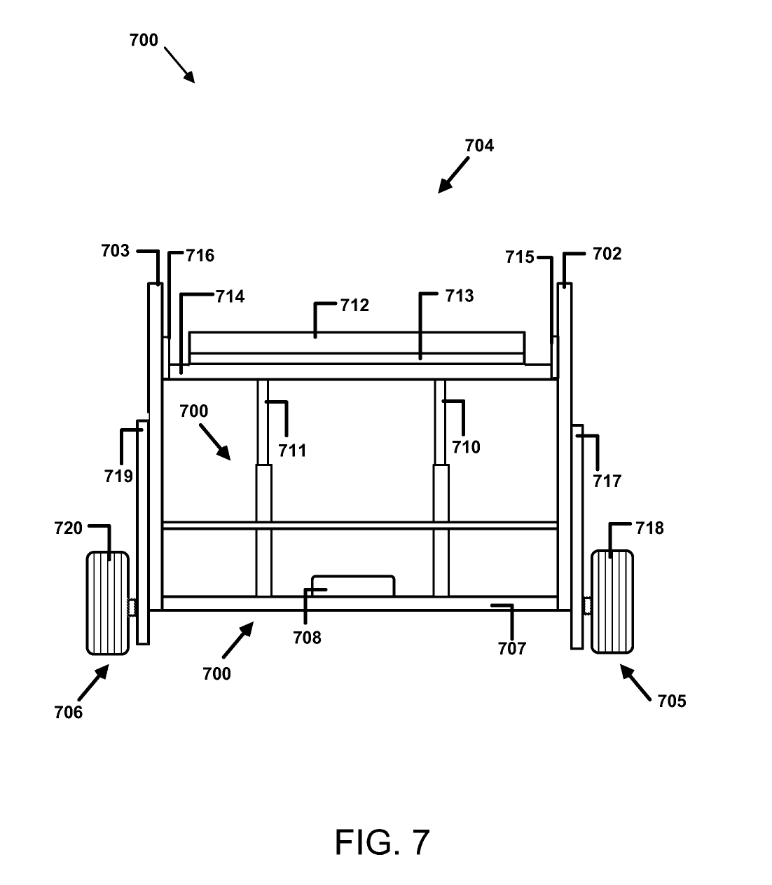

FIG. 7 is a left-side-view drawing illustrating an exemplary portable unloading dock 700 in transit mode with the curved ramp in the lowered position. The portable unloading dock 700 includes a lower frame 701, a first post member 702, a second post member 703, a curved ramp 704, a first wheel apparatus 705, and a second wheel apparatus 706.

The lower frame 701 includes first lower frame member (not shown), a second lower frame member (not shown), a first cross-frame member 707, a second cross-frame member (not shown), and a third cross-frame member (not shown).

In one embodiment, a power generator 708 is mechanically coupled to the support linkage 709. In another embodiment, the power generator 708 is mechanically coupled to the first cross-frame member 707. In yet another embodiment, the power generator 708 is mechanically coupled to the third cross-frame member (not shown).

In one embodiment, the first post member 702 is mechanically coupled to first lower frame member (not shown).

The support linkage 709 includes a first support linkage member (not shown), a second support linkage member (not shown), a first support lifting member 710, and a second support lifting member 711.

The curved ramp 704 is mechanically coupled to the lower frame 701, and pivots about the second cross-frame member (not shown) when the curved ramp 704 is raised and lowered. The curved ramp 704 also includes a second ramp 712 that is mechanically coupled to the hinge 713. The second ramp 712 may be lowered on to the truck bed to allow for easy transfer of wheeled vehicles from the truck bed to the portable unloading dock 700. The curve ramp 704 also includes a first ramp frame member 714, a second ramp frame member 715, a first cross ramp frame member 716, a second cross ramp frame member (not shown), and a third cross ramp frame member (not shown).

The first wheel apparatus 705 includes a first wheel shaft 717, a first wheel shaft coupler (not shown), a first wheel 718, and a first wheel axle (not shown). The first wheel shaft coupler (not shown) is mechanically coupled to the curved ramp 704 and allows the first wheel apparatus 705 to be raised and lowered. In FIG. 7, the first wheel apparatus 705 is in the raised position, which places the portable unloading dock 700 on the floor and the curved ramp 704 is in the extended position. In FIG. 7, the first wheel apparatus 705 is in the raised position, which places the portable unloading dock 700 on the floor and the curved ramp 704 is in the lowered position, which enables the portable unloading dock 700 to be moved from one location to another location.

The second wheel apparatus 706 includes a second wheel shaft 719, a second wheel shaft coupler (not shown), a second wheel 720, and a second wheel axle (not shown). The second wheel shaft coupler (not shown) is mechanically coupled to the curved ramp 704 and allows the second wheel apparatus 706 to be raised and lowered. In FIG. 7, the second wheel apparatus 706 is in the raised position, which places the portable unloading dock 700 on the ground and the curved ramp 704 to be moved from one location to another location.

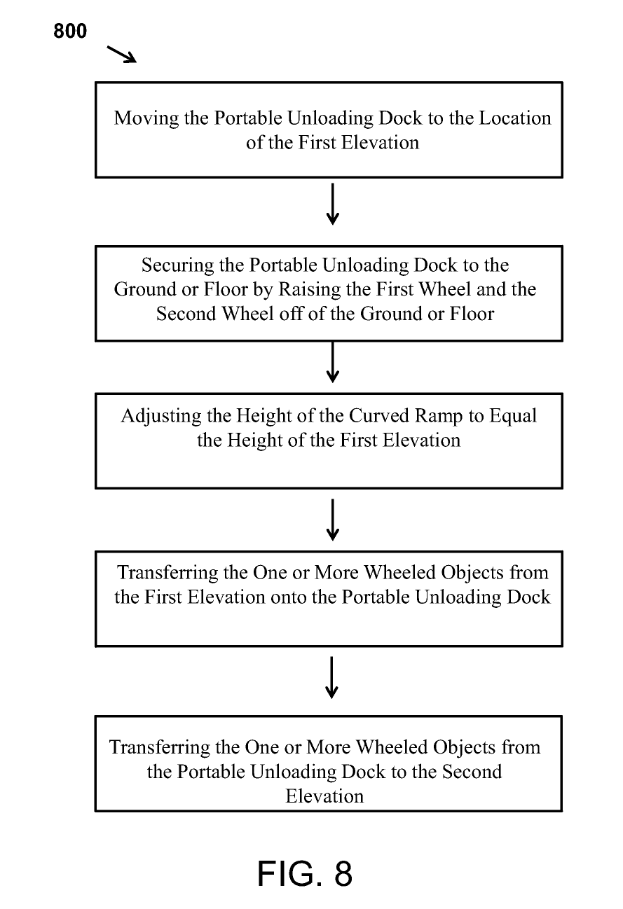

FIG. 8 is a block diagram illustrating a method 800 of using a portable unloading dock to transfer one or more wheeled objects from a first elevation to a second elevation. The method 800 includes: moving the portable unloading dock to a first elevation; securing the portable unloading dock to the ground or floor by raising the first wheel and the second wheel off of the ground or floor; adjusting the height of the curved ramp to equal the height of the first elevation; transferring the one or more wheeled objects from the first elevation onto the portable unloading dock; and transferring the one or more wheeled objects from the portable unloading dock to the second elevation.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, the claims referred to above including but not limited to any original claims.

What is claimed is:

1. A portable unloading dock comprising:
a lower frame comprising:
a first lower frame member having a proximal end and a distal end;
a second lower frame member having a proximal end and a distal end, wherein the first lower frame member and the second lower frame member are substantially parallel to each other;
a first cross-frame member having a proximal end and a distal end, wherein the proximal end of the first cross member is mechanically coupled to the proximal end of the first lower frame member and the distal end of the first cross member is mechanically coupled to the proximal end of the second lower frame member;
a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member;
one or more optional third cross-frame members each having a proximal end and a distal end,
wherein each proximal end of the one or more optional third cross-frame members is independently mechanically coupled to the first lower frame member;
wherein each distal end of the one or more optional third cross-frame members is independently mechanically coupled to the second lower frame member;
a first post member having a proximal end and a distal end, wherein the proximal end is mechanically coupled to the proximal end of the first lower frame member, the proximal end of the first cross-frame member, or a combination thereof;
a second post member having a proximal end and a distal end, wherein the proximal end is mechanically coupled to the proximal end of the second lower frame member, the distal end of the first cross-frame member, or a combination thereof;
a support linkage comprising:
one or more support linkage members each having a proximal end and a distal end,
wherein each of the proximal ends of the one or more support linkage members is independently mechanically coupled to the first cross-frame member, and
wherein each of the distal ends of the one or more support linkage members is independently mechanically coupled to the proximal ends and the distal ends of the one or more optional third cross-frame members or the second cross-frame member;
one or more support lifting members each having a proximal end and a distal end,
wherein each of the proximal ends of the one or more support lifting members is independently mechanically coupled to the proximal ends and the distal ends of the one or more support linkage members, the one or more optional third cross-frame members, or the second cross-frame member;
a curved ramp having a proximal end, a distal end, a first surface, and a second surface, wherein the curved ramp comprises:
a first ramp frame member having a proximal end and a distal end;
a second ramp frame member having a proximal end and a distal end, wherein the first ramp frame member and the second ramp frame member are substantially parallel to each other;
a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member;
a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member;
one or more optional third ramp cross-frame members each having a proximal end and a distal end,
wherein each proximal end of the one or more optional third ramp cross-frame members is independently mechanically coupled to the first ramp frame member,
wherein each distal end of the one or more optional third ramp cross-frame members is independently mechanically coupled to the second ramp frame member,
wherein the curved ramp is mechanically coupled to each of the distal ends of the one or more support lifting members,
wherein the distal end of the curved ramp is mechanically coupled to the second cross-frame member;
one or more power generators each independently mechanically coupled to or electrically coupled to the one or more support lifting members to raise the proximal end of the curved ramp;
one or more first wheel apparatus each independently mechanically coupled to the first ramp frame member; and
one or more second wheel apparatus each independently mechanically coupled to the second ramp frame member;
wherein the portable unloading dock is used to transfer one or more wheeled objects from a first elevation to a second elevation.

2. The portable unloading dock of claim 1, further comprising a first ramp guard member mechanically coupled to the first ramp frame member or to the first surface of the curved ramp.

3. The portable unloading dock of claim 1, further comprising a second ramp guard member mechanically coupled to the second ramp frame member or to the first surface of the curved ramp.

4. The portable unloading dock of claim 1, wherein the first surface of the curved ramp comprises one or more grates, one or more solid plates, or a combination thereof.

5. The portable unloading dock of claim 1, wherein the first surface of the curved ramp comprises one or more grates.

6. The portable unloading dock of claim 1, wherein the one or more support lifting members each independently comprise one or more hydraulic cylinders, one or more compressed gas cylinders, or a combination thereof.

7. The portable unloading dock of claim 1, wherein the one or more support lifting members each independently comprise one or more hydraulic cylinders.

8. The portable unloading dock of claim 1, wherein the one or more power generators each independently comprise one or more hydraulic fluid compressors, one or more gas compressors, one or more compressed gas cylinders, one or more electrical power sources, or a combination thereof.

9. The portable unloading dock of claim 1, wherein the one or more power generators each independently comprise one or more hydraulic fluid compressors.

10. The portable unloading dock of claim 1, wherein the one or more first wheel apparatus and the one or more second wheel apparatus are lowered to raise the portable unloading dock off a first elevation enable a user to transport the portable unloading dock.

11. The portable unloading dock of claim 1, wherein the one or more first wheel apparatus and the one or more second wheel apparatus are raised to place the portable unloading dock on a first elevation enable a user to transfer one or more vehicles from a first elevation to a second elevation.

12. The portable unloading dock of claim 1, wherein the one or more first wheel apparatus and the one or more second wheel apparatus are raised to place the portable unloading dock on a floor to enable a user to transfer one or more vehicles from a truck bed or trailer bed to the floor to a truck bed or a trailer bed.

13. The portable unloading dock of claim 1, wherein the first elevation is higher than the second elevation.

14. The portable unloading dock of claim 1, wherein the first elevation comprises a truck bed, a trailer bed, or a first loading dock.

15. The portable unloading dock of claim 1, wherein the second elevation comprises a ground or a floor.

16. The portable unloading dock of claim 1, wherein the distal end of the curved ramp is mechanically coupled to the second cross-frame member to pivot about the second cross-frame member when the one or more power generators supply a force to the one or more support lifting members to raise the proximal end of the curved ramp.

17. The portable unloading dock of claim 1, further comprising one or more first limit sensors to prevent the curved ramp from traveling in an upward direction beyond a predetermined height.

18. The portable unloading dock of claim 1, further comprising one or more second limit sensors to prevent the curved ramp from traveling in a downward direction beyond a predetermined height.

19. A portable unloading dock comprising:
a lower frame comprising;
a first lower frame member having a proximal end and a distal end;
a second lower frame member having a proximal end and a distal end, wherein the first lower frame member and the second lower frame member are substantially parallel to each other;
a first cross-frame member having a proximal end and a distal end, wherein the proximal end of the first cross member is mechanically coupled to the proximal end of the first lower frame member and the distal end of the first cross member is mechanically coupled to the proximal end of the second lower frame member;
a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member;
one or more optional third cross-frame members each having a proximal end and a distal end,
wherein each proximal end of the one or more optional third cross-frame members is independently mechanically coupled to the first lower frame member;
wherein each distal end of the one or more optional third cross-frame members is independently mechanically coupled to the second lower frame member;
a first post member having a proximal end and a distal end, wherein the proximal end is mechanically coupled to the proximal end of the first lower frame member, the proximal end of the first cross-frame member, or a combination thereof;
a second post member having a proximal end and a distal end, wherein the proximal end is mechanically coupled to the proximal end of the second lower frame member, the distal end of the first cross-frame member, or a combination thereof;
a support linkage comprising:
one or more support linkage members each having a proximal end and a distal end,
wherein each of the proximal ends of the one or more support linkage members is independently mechanically coupled to the first cross-frame member, and
wherein each of the distal ends of the one or more support linkage members is independently mechanically coupled to the proximal ends and the distal ends of the one or more optional third cross-frame members or the second cross-frame member;
one or more support lifting members each having a proximal end and a distal end,
wherein each of the proximal ends of the one or more support lifting members is independently mechanically coupled to the proximal ends and the distal ends of the one or more support linkage members, the one or more optional third cross-frame members, or the second cross-frame member,
wherein the one or more support lifting members comprise one or more hydraulic cylinders;
a curved ramp having a proximal end, a distal end, a first surface, and a second surface, wherein the curved ramp comprises:
a first ramp frame member having a proximal end and a distal end;
a second ramp frame member having a proximal end and a distal end, wherein the first ramp frame member and the second ramp frame member are substantially parallel to each other;
a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member;
a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member;
one or more optional third ramp cross-frame members each having a proximal end and a distal end,
wherein each proximal end of the one or more optional third ramp cross-frame members is independently mechanically coupled to the first ramp frame member,
wherein each distal end of the one or more optional third ramp cross-frame members is independently mechanically coupled to the second ramp frame member,
wherein the curved ramp is mechanically coupled to each of the distal ends of the one or more support lifting members,
wherein the distal end of the curved ramp is mechanically coupled to the second cross-frame member,
wherein the first surface of the curved ramp comprises one or more grates;
one or more power generators each independently mechanically coupled to or electrically coupled to the one or more support lifting members to raise the proximal end of the curved ramp, wherein the one or more power generators comprise one or more hydraulic fluid compressors;
one or more first wheel apparatus each independently mechanically coupled to the first ramp frame member;
one or more second wheel apparatus each independently mechanically coupled to the second ramp frame member;
a first ramp guard member mechanically coupled to the first ramp frame member or to the first surface of the curved ramp; and
a second ramp guard member mechanically coupled to the second ramp frame member or to the first surface of the curved ramp,
wherein the portable unloading dock is used to transfer one or more wheeled objects from a first elevation to a second elevation.

20. A method of transferring one or more wheeled objects from a first elevation to a second elevation, wherein the method comprises:
providing a portable unloading dock comprising:
a lower frame comprising:
a first lower frame member having a proximal end and a distal end;
a second lower frame member having a proximal end and a distal end, wherein the first lower frame member and the second lower frame member are substantially parallel to each other;
a first cross-frame member having a proximal end and a distal end, wherein the proximal end of the first cross member is mechanically coupled to the proximal end of the first lower frame member and the distal end of the first cross member is mechanically coupled to the proximal end of the second lower frame member;
a second cross-frame member having a proximal end and a distal end, wherein the proximal end of the second cross member is mechanically coupled to the distal end of the first lower frame member, wherein the distal end of the second cross member is mechanically coupled to the distal end of the second lower frame member;
one or more optional third cross-frame members each having a proximal end and a distal end,
wherein each proximal end of the one or more optional third cross-frame members is independently mechanically coupled to the first lower frame member;
wherein each distal end of the one or more optional third cross-frame members is independently mechanically coupled to the second lower frame member;
a first post member having a proximal end and a distal end, wherein the proximal end is mechanically coupled to the proximal end of the first lower frame member, the proximal end of the first cross-frame member, or a combination thereof;
a second post member having a proximal end and a distal end, wherein the proximal end is mechanically coupled to the proximal end of the second lower frame member, the distal end of the first cross-frame member, or a combination thereof;
a support linkage comprising:
one or more support linkage members each having a proximal end and a distal end,
wherein each of the proximal ends of the one or more support linkage members is independently mechanically coupled to the first cross-frame member, and
wherein each of the distal ends of the one or more support linkage members is independently mechanically coupled to the proximal ends and the distal ends of the one or more optional third cross-frame members or the second cross-frame member;
one or more support lifting members each having a proximal end and a distal end,
wherein each of the proximal ends of the one or more support lifting members is independently mechanically coupled to the proximal ends and the distal ends of the one or more support linkage members, the one or more optional third cross-frame members, or the second cross-frame member;
a curved ramp having a proximal end, a distal end, a first surface, and a second surface, wherein the curved ramp comprises:
a first ramp frame member having a proximal end and a distal end;
a second ramp frame member having a proximal end and a distal end, wherein the first ramp frame member and the second ramp frame member are substantially parallel to each other;
a first ramp cross-frame member having a proximal end and a distal end, wherein the proximal end of the first ramp cross member is mechanically coupled to the proximal end of the first ramp frame member and the distal end of the first ramp cross member is mechanically coupled to the proximal end of the second ramp frame member;
a second ramp cross-frame member having a proximal end and a distal end, wherein the proximal end of the second ramp cross member is mechanically coupled to the distal end of the first ramp frame member and the distal end of the second ramp cross member is mechanically coupled to the distal end of the second ramp frame member;
one or more optional third ramp cross-frame members each having a proximal end and a distal end,
wherein each proximal end of the one or more optional third ramp cross-frame members is independently mechanically coupled to the first ramp frame member,
wherein each distal end of the one or more optional third ramp cross-frame members is independently mechanically coupled to the second ramp frame member,
wherein the curved ramp is mechanically coupled to each of the distal ends of the one or more support lifting members,
wherein the distal end of the curved ramp is mechanically coupled to the second cross-frame member;
one or more power generators each independently mechanically coupled to or electrically coupled to the one or more support lifting members to raise the proximal end of the curved ramp;
one or more first wheel apparatus each independently mechanically coupled to the first ramp frame member; and
one or more second wheel apparatus each independently mechanically coupled to the second ramp frame member;
moving the portable unloading dock to a first elevation;
securing the portable unloading dock to a first elevation by raising the first wheel and the second wheel off the first elevation;
adjusting the curved ramp to the first elevation;
transferring the one or more wheeled objects from the first elevation onto the portable unloading dock; and
transferring the one or more wheeled objects from the portable unloading dock to the second elevation.
